(19) United States
(12) Patent Application Publication
(10) Pub. No.: US 2010/0287136 A1
(43) Pub. Date: Nov. 11, 2010

(54) Method and system for the recognition and tracking of entities as they become famous

(76) Inventors: Joseph A. Fortuna, JR., Lake Huntington, NY (US); George Kevin Fortuna, Cold Spring, NY (US)

Correspondence Address: WHITEFORD, TAYLOR & PRESTON, LLP;ATTN: GREGORY M STONE, SEVEN SAINT PAUL STREET, BALTIMORE, MD, 21202-1626, US

(21) Appl. No.: 12/803,993

(22) Filed: Jul. 12, 2010

Related U.S. Application Data
(63) Continuation-in-part of application No. 11/698,014, filed on Jan. 25, 2007, now Pat. No. 7,756,720.
(60) Provisional application No. 60/762,082, filed on Jan. 25, 2006.

(51) Int. Cl. G06F 17/30

(52) U.S. Cl. 707/601; 707/E17.048; 707/E17.052

(57) ABSTRACT

A system and method for recognizing an entity rising in public awareness and tracking the growth of such awareness through the automated analysis and collection of quantitative and contextual frame-related data, and for presenting an objective measurement to one or more users of such system. A first portion of the invention is directed toward initial recognition of an entity wherein the system detects proper nouns of a person, place, or thing using natural language algorithms to detect patterns. A second portion of the invention is directed toward detection of popularity lift wherein the system uses a variety of methods to detect popularity lift, including frequency of mentions in RSS feeds, search engine reporting, and various user inputs such as user-generated content, data available in various social media forums, and Internet usage patterns.

### CROSS REFERENCE TO RELATED APPLICATION

This application is a continuation-in-part of U.S. patent application Ser. No. 11/698,014, now U.S. Pat. No. 7,756,720, filed with the U.S. Patent and Trademark Office on Jan. 25, 2007, which is based upon and claims benefit of U.S. Provisional Patent Application Ser. No. 60/762,082, filed with the U.S. Patent and Trademark Office on Jan. 25, 2006, the specifications of which are incorporated herein by reference.

### BACKGROUND OF THE INVENTION

1. Field of the Invention

This invention relates to a system and method for recognizing an entity rising in public awareness and tracking the growth of such awareness through the automated analysis and collection of quantitative and contextual frame-related data, and for presenting an objective measurement to one or more users of such system.

2. Background

Frame, i.e., the extent to which a person or entity's frame status or notoriety makes them known to the public, carries commercial value. Interest has risen over more than the last decade to recognize and exploit such commercial value, with providers of goods and services seeking to exploit a person's frame by associating such person with their product or service, whether by way of seeking formal endorsement or simply (and at times in violation of such person's right of publicity) trading on their reputation through direct or implied association. Disputes have arisen over misappropriation of a famous person's identity for commercial advantage. Producers of new television programs and motion pictures often seek actors with greater celebrity status to increase the audience for their program or picture. In most instances, the greater a person's celebrity, the greater the commercial value that can be associated with such person's identity. Similarly, as restaurants or places of interest gain in popularity, proprietors of such places can adjust their fees appropriately. However, a person or entity's celebrity status is largely reduced to the power of the public relations machinery behind such person or entity. Such celebrity status is typically only as powerful and/or valuable as the ability to remain in the news. Except for those celebrities or entities that are already well known, how does one determine and identify a “rising star?” Unfortunately, to date, no objective measurement exists that can recognize an entity as it becomes “famous” and track the progress of the growth of frame.

### SUMMARY OF THE INVENTION

It would be advantageous to create a system to collect and analyze data in order to objectively recognize and measure the growth of frame pertaining to celebrities and entities, which data would be useful to those who seek to exploit the commercial value of celebrities and popular entities.

Disclosed is a collection of computer programs that uses the vast amount of interconnected data available on the Internet to recognize popularity growth and generate an objective measurement of popularity growth. This information typically takes the form of public news feeds being released by traditional news media outlets, public relations firms, and private citizens. Much of this information is published in RSS (Really Simple Syndication) format, an open standard on the Internet, which is rapidly becoming the default protocol for news syndication. RSS is a family of web feed formats used to publish frequently updated pages, such as blogs or news feeds.

In a first portion of the invention, directed toward initial recognition of an entity, the system detects proper nouns of a person, place, or thing using natural language algorithms to detect patterns. In a second portion of the invention, directed toward detection of popularity lift, the system uses a variety of methods to detect popularity lift, including frequency of mentions in RSS feeds, user inputs, search engine reporting such as Google trends, etc

A relational database is disclosed, which preferably includes specific data and statistics concerning people and entities, as well as a growing corpus of data taken from the above-mentioned sources. The database is preferably both automatically maintained and hand-edited by a human.

The system may perform a combination of word-stemming, TD/IDF analysis, and N-gram analysis to identify pertinent sentences and data points and to tag those data points for extraction and inclusion in a summary, which provides a general qualitative indication of the news being summarized.

The various features of novelty that characterize the invention will be pointed out with particularity in the claims of this application.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 is a block diagram showing database generation according to a first embodiment of the present invention.

### DETAILED DESCRIPTION OF EXEMPLARY EMBODIMENTS

The invention summarized above and defined by the enumerated claims may be better understood by referring to the following description, which should be read in conjunction with the accompanying drawings. This description of an embodiment, set out below to enable one to build and use an implementation of the invention, is not intended to limit the invention, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

In a particularly preferred embodiment of the invention, the system (and the method employed by such system) divides its functions into three major functional components: Database Generation, Recognition, Popularity Lift, and Presentation. Subject to the nature of the request made by a user, each process can be asynchronous to every other, or several processes can follow on one another as dependencies. Each case is described below. In addition, while the system and method are described herein by way of recognizing and tracking the frame associated with an individual, such is by way of example only, and those of ordinary skill in the art will readily recognize that such system and method are likewise applicable to quantifying the frame, notoriety, or like attribute of other persons, places, or things.

### Database Generation

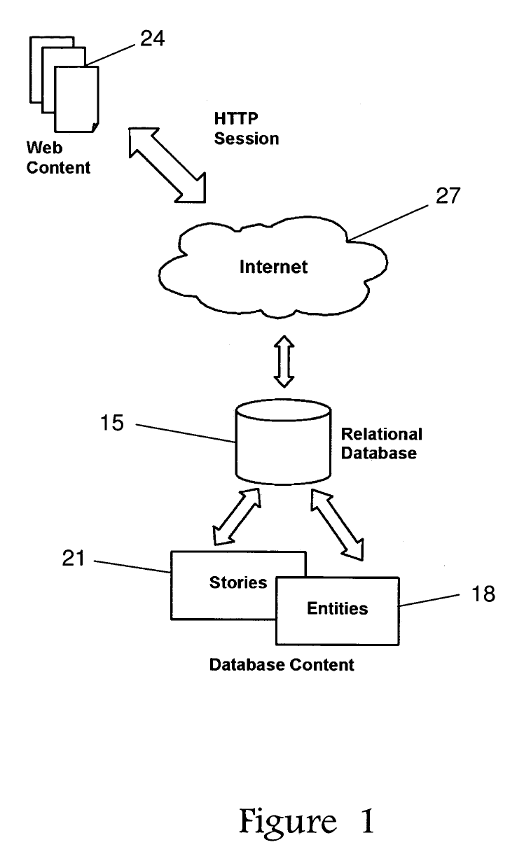

As shown in FIG. 1, the system uses a relational database structure for organization of collected data. The major tables of information in the relational database 15 are preferably: Stories, Entities, FrameTypes (categories of celebrity), StarTypes (many to many mapping between Entities and FrameTypes), and StarStories (a many to many mapping between Entities and Stories). The Entities table 18 preferably contains identification data specific to each identified entity (name, gender, age, location, etc., as appropriate). The Stories table 21 preferably contains celebrity-related news and information gathered by a Data Generation process, described in more detail below. Stories are formatted to preferably include date, story title, story source, story abstract, and story text. Additional fields preferably include story-specific photo file, duration of chat (if information is harvested by a chat bot, as described below), and reply count (if information is harvested from a message board).

The StarStories table may include fields for both StoryId and StarId, as well as fields that indicate whether a given story is considered a “Strong Match” for a given entity. A strong match is determined by a combination of frequency of mention of the celebrity, whether the celebrity is listed (included in a comma-delimited list of other celebrities) or referred to explicitly, and the occurrence of the celebrity's name in any available title.

Within the text of a story, celebrity names are tagged, in standard XML format as <PERSON>. Names may be identified in a number of ways. In several formats (particularly those harvested from deep links identified in RSS feeds provided by formal news outlets) celebrity names may be encased in very easily identifiable blocks of JavaScript, or clearly labeled DOM elements (e.g., classnames for <div> elements). Using this method, and through hand editing and accumulation, the system creates a celebrity database—a list of names known to be celebrities. This list is amended on an ongoing basis, both by the application and by the application's engineers.

The system detects proper nouns of a person, place, or thing using natural language algorithms to detect patterns. For example, two words with initial caps that meet “person” attributes (i.e. match to a DB of names) and are followed by a verb will be recognized to denote a person. To the extent that this entity does not match with another proper noun in the database of “famous names” then it will be recognized to be new and worthy of tracking.

In the absence of both specific HTML indicators and recognition of a learned name, names are extracted by regular expression pattern matching. Specifically, matching against the following pattern: “\\s([A-Z][a-z]+[A-Z][a-z][a-zA-Z][a-z]+([A-Z][a-z]+)?” A further refinement to pattern matching includes verb parsing based on syntactically correct placement of a known list of verbs in and around the matched pattern. Verbs are parsed according to conjugated forms as well as lexical stems.

Finally, domain-specific terminology is used to identify celebrity names within a document. Words, such as “diva,” “heartthrob,” “legend,” etc., exist in the database in a separate table and are used to locate sentences within which there is a high likelihood of the presence of a celebrity name.

All of these methods are used in concert—along with hand editing of the results.

Celebrity-related information (the content, or data within which the aforementioned references to celebrities are found) is drawn from a number of sources available as raw web content 24. Most useful are hard news sources from formal outlets, such as AP, Reuters, E! Online, etc. This data is publicly available over the Internet 27 as RSS feeds. Within each feed, on a per-story basis, date, title, and abstract information are specifically tagged, as is a link to a deeper story available on the Internet 27. The system parses these tags, storing the relevant information in the database.

Other web content 24 that is available in similar RSS format includes celebrity blogs (web logs maintained by the celebrities themselves), fan blogs (web logs maintained by a celebrity fan base), and general blogs (web logs maintained by otherwise disinterested parties—which may include information about a given celebrity). A list of these feeds is maintained by the system, based on the results of automated web searches, and a WebCrawler designed to pursue related links throughout the Internet 27.

All RSS feeds are preferably acquired using HTTP GET commands, scheduled and automatically launched by the system. As mentioned above, any follow-up requests for deeper content referred to in the feeds are also preferably made via HTTP GET commands. Once acquired, all data is then sifted, scrubbed, tagged, and stored as described above.

### Recognition

To identify a potential celebrity, the system first does a regular expression match on all unigrams, bigrams, and trigrams where each word in the tuple begins with a capital letter. In addition, information about any “bracketing” words is preserved. In other words, if the system identifies the word “Tiger” in a sentence, it also preserves the detail that the word “legend” and “debased” occur before and after the word, respectively.

The system scans through the various ‘grams and does a check within the repository for confidence statistics of all known entities of that ‘gram length. Confidence metrics include raw frequency of occurrence of the single-word entity (as such), frequency of occurrence with both bracketed terms, and frequency of occurrence with preceding or succeeding bracketed terms. Confidence is established by measuring the frequency of the above-mentioned occurrences, where the entity has been confirmed as an actual entity against the frequency of occurrence in each case where the word has been identified as a non-entity. If a human being has identified a previous occurrence as a proper entity, then the metric will be increased by an experimentally defined constant. The system is also empowered to make its own evaluation of whether the entity is proper or not. In either case, if the various confidence metrics exceed a certain threshold, then the entity is tagged as a proper entity. If the metrics fall below a certain threshold, then the entity is tagged as a non-entity. If the metrics fall between the two thresholds, then the entity is tagged for human evaluation.

Each entity should be identified as having been validated by either the system or a human editor.

“Proper” entities that have been identified by the system will have their metrics augmented by each occurrence of the name, and periodic checks by a human editor can tip the confidence level of these over the edge.

Note that the process is essentially recursive in nature. Beginning with an empty repository of confidence statistics, the system slowly generates a greater knowledge base over time. Still, even with an empty repository, the system will check against the accumulated knowledge, to date. Over time, more and more statistics will be acquired and applied toward the metrics, and overall confidence levels will increase.

### Popularity Lift

The system uses a variety of methods to detect popularity lift, including frequency of mentions in RSS feeds, search engine reporting such as Google trends, various user inputs, etc. Such user inputs may include, by way of non-limiting example, various forms of user-generated content (e.g., making available to users data entry and editing utilities so that the system users may themselves maintain the database), data available in various social media forums (e.g., FACEBOOK, TWITTER, etc.), and Internet usage patterns that may show various changes in both user-generated content and user activity on the Internet in general (e.g., search patterns, purchase patterns, reviews, etc.).

Another element of the system is its process of “harvesting” information from the web. Such harvesting includes gathering data from stories from syndicated news sources, ranked lists from user-generated list sites, search statistics from search engines that make this information public, statistics from public discussion boards, and editorially-defined associative data pertaining to each entity. An example of this would be, box-office proceeds from an entity identified as a proper entity who is a movie star, or stock price from an entity identified as a company. The system includes a mechanism for allowing an editorial staff member to define this type of associative data.

In each case, statistics are preserved of the relative activity for each entity, that is, the frequency of occurrence of an entity name. Relative in this context refers to the change in frequency over the previous 24 hours, the previous week, the previous month, and the previous year. The system identifies changes in entity activity and reports on scale and recency over each time span.

Recent spikes or sudden increase in activity over a previous week or day may indicate a lift in popularity. Gradual spikes such as a slow but monotonous increase in activity over the previous month or year may, likewise, indicate a strong rise in popularity. The negative image of these types of changes is also determined and reported.

### Presentation

Given all of the mechanisms mentioned above, and the existence of an underlying relational database, the final presentation of the data can take many forms. In general, the data may be available to a user who accesses a particular website on the Internet. For example, entities may be ranked in descending order of the frame weight assigned in the manner described above. Ranking may be done by type, i.e. person, place, or thing, or by growth. Other methods and combinations of rankings may be used. The data may be presented as a series of HTML pages, and rankings or listings may be generated on a daily, weekly, and/or monthly basis. In addition, an “all-time” rank may be given for each entity. Such information may be textual, graphic, or combinations of textual and graphic displays.

The invention has been described with references to a preferred embodiment. While specific values, relationships, materials and steps have been set forth for purposes of describing concepts of the invention, it will be appreciated by persons skilled in the art that numerous variations and/or modifications may be made to the invention as shown in the specific embodiments without departing from the spirit or scope of the basic concepts and operating principles of the invention as broadly described. It should be recognized that, in the light of the above teachings, those skilled in the art could modify those specifics without departing from the invention taught herein. Having now fully set forth the preferred embodiments and certain modifications of the concept underlying the present invention, various other embodiments as well as certain variations and modifications of the embodiments herein shown and described will obviously occur to those skilled in the art upon becoming familiar with such underlying concept. It is intended to include all such modifications, alternatives and other embodiments insofar as they come within the scope of the appended claims or equivalents thereof. It should be understood, therefore, that the invention might be practiced otherwise than as specifically set forth herein. Consequently, the present embodiments are to be considered in all respects as illustrative and not restrictive.

What is claimed is:

1. A computer implemented method of identifying an entity and tracking its progress of frame, comprising the steps of:
establishing a relational database for holding information about a plurality of entities, said information being arranged in a plurality of tables in the database, wherein such information is obtained from stories that contains entity related news and information gathered by a data generation process;
gathering one or more stories from a plurality of sources;
parsing the stories to determine specific indicators of one or more entities;
storing said stories in said relational database with appropriate tags to enable retrieval by a user of the database;
wherein such information contains data selected from the group consisting of:
name;
gender;
age;
location; and
type of entity
said database including many to many mapping between the identification of the entity to the type of entity and many to many mapping between the identification of the entity to the stories;
providing a quantification engine having software for use in a computer processor adapted to execute said software, said quantification engine
determining confidence metrics including determining frequency of occurrence of an entity identifier, and
tracking changes in frequency of occurrence of an entity identifier; and presenting a summary for viewing by said user.

2. The method of claim 1, wherein said method is performed for a plurality of entities.

3. The method of claim 1, wherein said method is performed for a plurality of types of entities.

4. The method of claim 1, wherein said stories are gathered over a global communication network.

5. The method of claim 1, wherein the step of parsing the stories further comprises the steps of:
tagging each story based on date, title, and abstract information;
matching patterns in the stories to a predetermined list of known entities;
identifying entity names using domain specific terminology;
identifying keywords in the story indicative of information about the entity.

6. The method of claim 1, wherein an entity is selected for consideration for tracking when each word in a tuple begins with a capital letter.

7. The method of claim 1, wherein the confidence metric is established by measuring the frequency of occurrence of identified terms in the stories.

8. The method of claim 1, further comprising the steps of:
determining a change in the frequency of occurrence of an entity name over a selected period of time.

9. The method of claim 8, wherein said selected period of time is daily, weekly, monthly and/or yearly.

10. The method of claim 1, further comprising:
using said computer processor to calculate score ranking for one or more entities on a daily, weekly, and/or monthly basis.
